(19) United States
(12) Patent Application Publication
(10) Pub. No.: US 2026/0016662 A1
(43) Pub. Date: Jan. 15, 2026

(54) IMAGING LENS AND METHOD FOR MANUFACTURING LENS APPARATUS

(71) Applicant: CANON KABUSHIKI KAISHA, Tokyo (JP)

(72) Inventor: TAKASHI OKADA, Saitama (JP)

(21) Appl. No.: 19/257,261

(22) Filed: Jul. 1, 2025

(30) Foreign Application Priority Data
Jul. 9, 2024 (JP) 2024-110109
Apr. 24, 2025 (JP) 2025-072234

(51) Int. Cl. G02B 13/00; G02B 7/04

(52) U.S. Cl. CPC G02B 13/0045; G02B 7/04; G02B 13/0055

(57) ABSTRACT

An imaging lens includes a first lens system including a first A lens group closest to an object and a positive lens group disposed on an image side of the first A lens group, and a second lens system in which a first B lens group is disposed in place of the first A lens group to set a focal length of an entire system to a telephoto side, and predetermined conditional expressions are satisfied.

### BACKGROUND

### Field of the Technology

The aspect of the embodiments is suitable for an imaging lens and a method for manufacturing a lens apparatus.

### Description of the Related Art

In recent years, in an imaging apparatus using a solid-state image pickup device such as a digital still camera or a video camera, there has been a demand for optical systems that have various focal lengths and various apertures depending on the application. Among these optical systems, a fixed focal length lens includes fewer movable lens groups than those in a zoom lens, so that its structure can be easily made robust, and a degree of design freedom is high. Thus, the fixed focal length lens can be easily provided with a small size, high performance, and at a low cost.

According to the related art discussed in Japanese Patent Application Laid-Open No. S61-129612, a rear lens group has weakly negative refractive power, and plays a small role in aberration correction of the entire system.

### SUMMARY

According to an aspect of the embodiments, an imaging lens includes a first lens system including a first A lens group closest to an object and a positive lens group disposed on an image side of the first A lens group, and a second lens system in which a first B lens group is disposed in place of the first A lens group to set a focal length of an entire system to a telephoto side, wherein following conditional expressions are satisfied: 0.01<|fP/f1A|<0.30, 0.01<|fP/f1B|<0.30, and 0.02<Σ1/(fPi·Ni)<0.10, where, when focused at infinity, fp indicates a focal length of the positive lens group, f1A indicates a focal length of the first A lens group, f1B indicates a focal length of the first B lens group, fPi indicates a focal length of each lens disposed in the positive lens group, and Ni indicates a refractive index of the lens.

According to another aspect of the embodiments, a method for manufacturing a first lens apparatus and a second lens apparatus includes assembling the first lens apparatus by combining a first partial optical system, a first aperture stop, and a second partial optical system disposed in order from an object side to an image side, and assembling the second lens apparatus by combining a third partial optical system, a second aperture stop, and a fourth partial optical system disposed in order from the object side to the image side, wherein a focal length of the second lens apparatus is longer than a focal length of the first lens apparatus, wherein a total number of positive lenses disposed in the second partial optical system and a total number of positive lenses disposed in the fourth partial optical system are equal, wherein a total number of negative lenses disposed in the second partial optical system and a total number of negative lenses disposed in the fourth partial optical system are equal, and wherein following conditional expressions are satisfied: 0.01<|fP/f1A [<0.30, 0.01<|fP/f1B]<0.30, 0.02<Σ1/(fPi·Ni)<0.10, and 0.90<f2/f4<1.10, where a focal length of the first partial optical system is f1A, a focal length of the third partial optical system is f1B, a focal length of each lens disposed in the second partial optical system is fPi, a refractive index is Ni, a focal length of the second partial optical system is f2, and a focal length of the fourth partial optical system is f4.

Features of the disclosure will become apparent from the following description of embodiments with reference to the attached drawings. The following description of embodiments is described by way of example.

### BRIEF DESCRIPTION OF THE DRAWINGS

FIGS. 1A and 1B are optical cross-sectional views respectively illustrating a first lens system and a second lens system in an imaging lens according to a first exemplary embodiment.

FIGS. 2A and 2B are aberration diagrams regarding the first lens system and the second lens system, respectively, in the imaging lens according to the first exemplary embodiment when focused at infinity.

FIGS. 3A and 3B are optical cross-sectional views respectively illustrating a first lens system and a second lens system in an imaging lens according to a second exemplary embodiment.

FIGS. 4A and 4B are aberration diagrams regarding the first lens system and the second lens system, respectively, in the imaging lens according to the second exemplary embodiment when focused at infinity.

FIGS. 5A and 5B are optical cross-sectional views respectively illustrating a first lens system and a second lens system in an imaging lens according to a third exemplary embodiment.

FIGS. 6A and 6B are aberration diagrams regarding the first lens system and the second lens system, respectively, in the imaging lens according to the third exemplary embodiment when focused at infinity.

FIG. 7 is a schematic view of an imaging apparatus according to the aspect of the embodiments.

### DESCRIPTION OF THE EMBODIMENTS

An imaging lens, an imaging apparatus including the imaging lens, and a manufacturing method according to the aspect of the embodiments will be described below.

As an aspect of the imaging lens in each exemplary embodiment of the disclosure, by replacing part of an optical system, it is possible to switch between two different focal lengths of a first lens system and a second lens system. The first lens system is composed of, in order from an object side, a first A lens group having weak refractive power, and a second lens group having positive refractive power. The second lens system is composed of, in order from the object side, a first B lens group having weak refractive power, and the second lens group having positive refractive power. By using the second lens group as a common component and interchanging the first A lens group and the first B lens group, it is possible to switch between two different focal lengths.

Here, with regard to a definition of a group when part of the optical system according to the disclosure is replaced, a group of lenses located on the front side or on the rear side of a lens group to be replaced to switch a focal length is defined as the group. More specifically, with regard to an optical system that moves part of lenses in a group, such as a partial group in which some lenses in the group perform focusing, or a partial group in which some lenses in the group perform image stabilization, such a group is not defined as the group. Grouping based on replacement is used in the description.

In the manufacturing method according to the disclosure, a first lens apparatus corresponds to the first lens system, and a second lens apparatus corresponds to the second lens system. Lenses disposed in the first lens apparatus and the second lens apparatus are not used in common and are different manufactured articles.

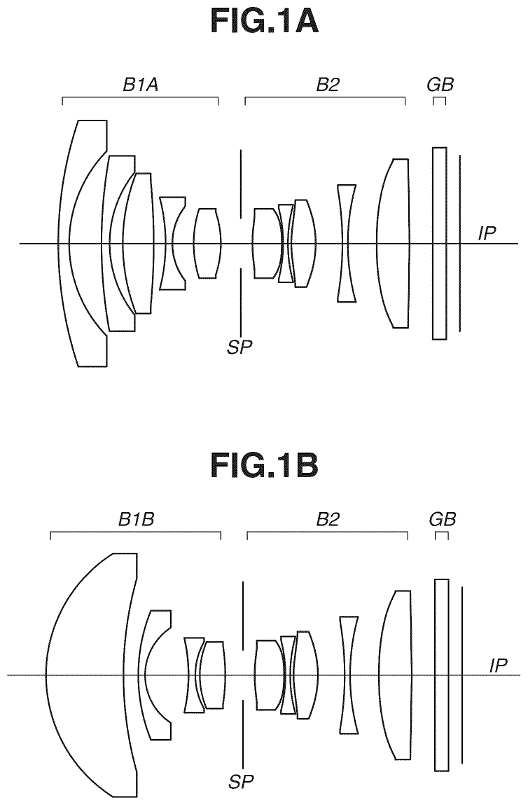

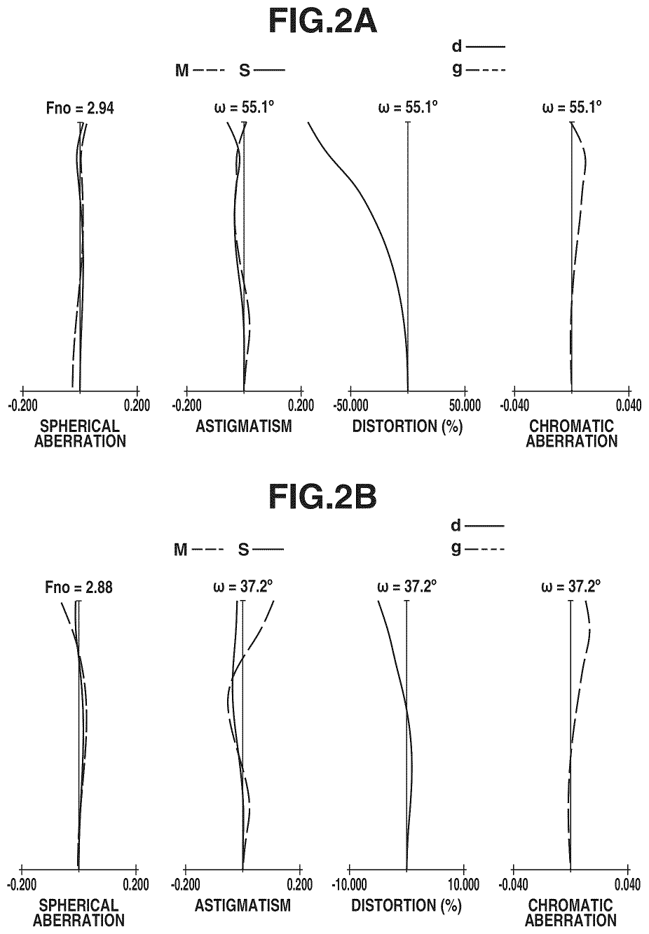

FIGS. 1A and 1B are optical cross-sectional views respectively illustrating the first lens system and the second lens system in the imaging lens according to a first exemplary embodiment. FIGS. 2A and 2B are aberration diagrams regarding the first lens system and the second lens system, respectively, in the imaging lens according to the first exemplary embodiment when focused at infinity.

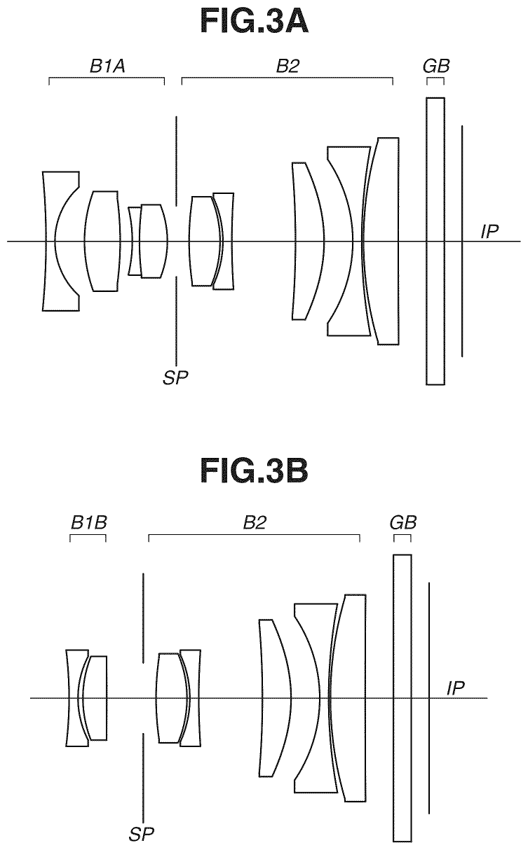

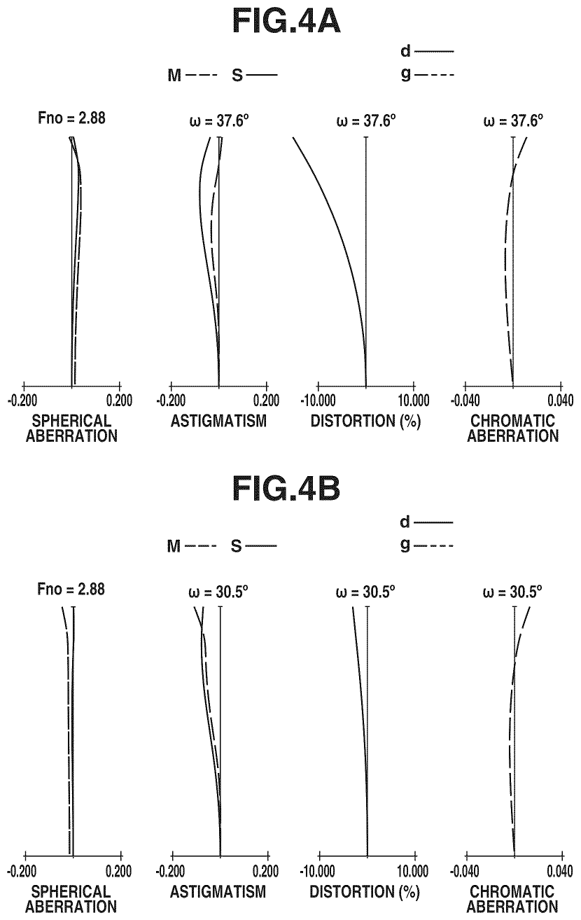

FIGS. 3A and 3B are optical cross-sectional views respectively illustrating a first lens system and a second lens system in an imaging lens according to a second exemplary embodiment. FIGS. 4A and 4B are aberration diagrams regarding the first lens system and the second lens system, respectively, in the imaging lens according to the second exemplary embodiment when focused at infinity.

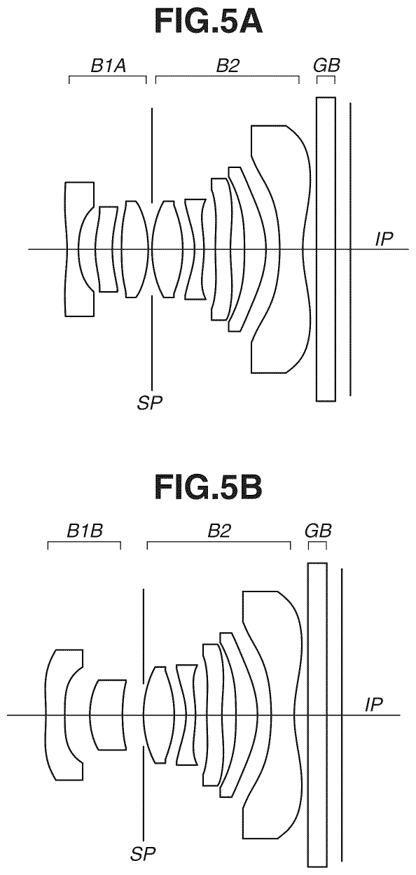

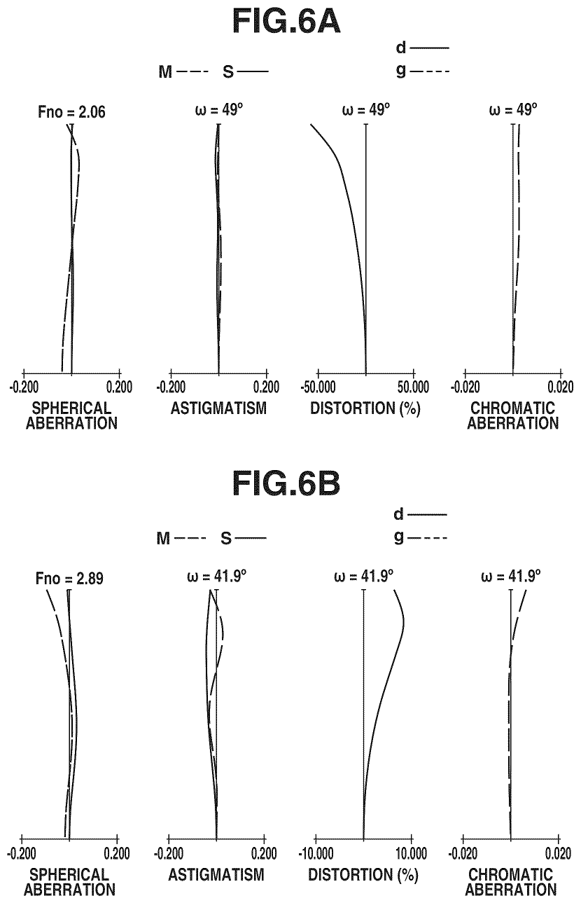

FIGS. 5A and 5B are optical cross-sectional views respectively illustrating a first lens system and a second lens system in an imaging lens according to a third exemplary embodiment. FIGS. 6A and 6B are aberration diagrams regarding the first lens system and the second lens system, respectively, in the imaging lens according to the third exemplary embodiment when focused at infinity.

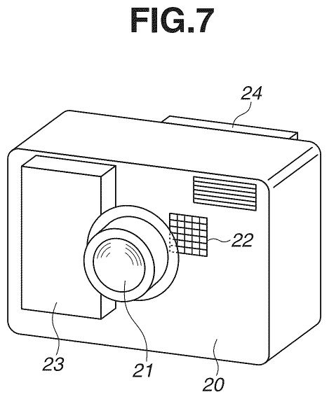

FIG. 7 is a view schematically illustrating a main portion of a camera (imaging apparatus) including the imaging lens according to the disclosure. The imaging lens according to each exemplary embodiment is an imaging lens system used in an imaging apparatus such as a video camera, a digital camera, or a silver-halide film camera. In the lens (optical) cross-sectional views, the left side corresponds to the object side (front side), and the right side corresponds to an image side (back side). In the lens cross-sectional views, i indicates the order of a lens group from the object side, and Bi indicates an i-th lens group.

In the lens cross-sectional views of the respective exemplary embodiments, B1A indicates the first A lens group, B1B indicates the first B lens group, and B2 indicates the second lens group.

In each exemplary embodiment, SP indicates an aperture stop, which is disposed on the object side of the second lens group. By disposing the aperture stop in an intermediate position between the first lens system and the second lens system, the optical system has a symmetrical arrangement, which makes it possible to correct a distortion aberration and a field curvature. This is advantageous in improving performance. Additionally, since the aperture stop is located away from a solid-state image pickup device, it is possible to make an incident angle of light on the solid-state image pickup device gentler, thereby it is possible to prevent deterioration of an image due to shading or the like, and is advantageous in improving image quality. While the aperture stop is disposed on the object side of the second lens group in the exemplary embodiment, a lens may be disposed on the object side of the aperture stop, and the aperture stop may be disposed within the second lens group in this case.

GB indicates an optical block corresponding to an optical filter, a face plate, a crystal low-pass filter, an infrared cut filter, or the like.

IP indicates an image plane. When the optical system is used as an imaging optical system of a video camera or a digital still camera, the image plane corresponds to an imaging plane of the solid-state image pickup device (photoelectric conversion device) such as a charge-coupled device (CCD) sensor or a complementary metal-oxide semiconductor (CMOS) sensor. In the case of a silver-halide film camera, a photosensitive surface corresponding to a film surface is disposed.

In each of the aberration diagrams, d indicates a d-line, g indicates a g-line, ΔM indicates a meridional image plane, ΔS indicates a sagittal image plane, and a chromatic aberration of magnification is indicated by the g-line. Further, ω indicates a half angle of view (a value half of the angle of view), and fno indicates an F-number.

In each exemplary embodiment, the first lens system of the imaging lens, which is one aspect of the disclosure and part of which is shared, is composed of the first A lens group and the second lens group with the aperture stop interposed therebetween. The second lens system is composed of the first B lens group and the second lens group with the aperture stop interposed therebetween. The second lens group has positive refractive power. The second lens group disposed on the image side is shared, and by replacing the first A lens group in front of the aperture stop with the first B lens group, it is possible to change a focal length of the first lens system and a focal length of the second lens system and switch the angle of view.

In focusing from infinity to close distances in each exemplary embodiment, in the first exemplary embodiment, focusing is performed by moving, in an optical axis direction, a fourth lens from the object side in the second lens group. This lens has negative refractive power, and focusing is performed by retracting the lens toward the image side at the time of focusing. In the second exemplary embodiment, focusing is performed by moving, in the optical axis direction, a third lens from the object side in the second lens group. This lens has positive refractive power, and focusing is performed by extending the lens toward the object side at the time of focusing. With such configurations in which focusing is performed using a single lens element as in the first and second exemplary embodiments, it is possible to reduce the weight and perform focusing at a high speed. Further, by disposing a focusing group in the shared second lens group, it is possible to provide a configuration that enables a user to easily perform replacement. Alternatively, even in a case where lenses are manufactured as separate lenses, a focusing mechanism can be shared. Thus, efficiency in development is increased, and a low cost can be achieved. In the third exemplary embodiment, focusing is performed by extending the entire first lens system or the entire second lens system. The third exemplary embodiment is designed to use a resin lens, and a lightweight material is used. Since the entire lens system is extended, an aberration is corrected. Thus, the third exemplary embodiment has an advantage that high performance can be achieved.

In each of the exemplary embodiments, the first A lens group is composed of two to five lenses. In all of the exemplary embodiments, the first A lens group is composed of one to two more lenses than the first B lens group. This is because the first lens system has a wider angle of view than the second lens system. Since light rays pass through an outer periphery portion of a lens in a wide-angle lens, the number of lenses is increased to correct a field curvature of peripheral rays.

The first A lens group and the first B lens group each include at least one positive lens and at least one negative lens. This is to correct a chromatic aberration in a group to be replaced, and is a measure for achieving high performance when a lens is replaced.

The second lens group has positive refractive power, and is composed of five lenses. Since the first A lens group and the first B lens group have small refractive power as described below, the second lens group provides a major part of refractive power in the first lens system and the second lens system as the entire system. Hence, in one embodiment, the number of lenses in the shared second lens group is to be larger than or equal to the number of lenses in the first A lens group and that in the first B lens group. Since a degree of design difficulty is reduced in a pan-focus lens or the like in which a focusing mechanism or the like is excluded, the number of lenses can be further reduced.

Additionally, since the second lens group is the shared group, in one embodiment, an aspherical lens is to be used in the second lens group and a spherical lens is to be used in the first A lens group and the first B lens group if possible. Since the second lens group provides a major part of refractive power in the first lens system and the second lens system, it has a high refractive power. Hence, by using the aspherical lens in the second lens group and efficiently correcting an aberration, it is possible to achieve miniaturization of the entire system. Assuming a case where lenses are manufactured as separate lenses, a production volume of aspherical lenses is increased by using the aspherical lenses in the shared lens group. Thus, the advantage of lower cost through mass production can be achieved. In the exemplary embodiment as well, the number of aspherical lenses in the second lens group is larger than the number of aspherical lenses in each of the first A lens group and the first B lens group. In this manner, the proposal is also advantageous in concentrating not only the aspherical lenses but also costly parts, such as the aperture stop, the focusing mechanism, and an image stabilizing mechanism, on the shared portion and increasing the number of these parts to reduce costs of the entire lens system.

Points of the disclosure are to set the refractive power of the first A lens group in the first lens system or the refractive power of the first B lens group in the second lens system to be weak and to set a t Petzval sum to be large on the negative side.

To achieve miniaturization of an optical system, a positive lens group having high refractive power is used, but a Petzval sum in such a positive lens group having high refractive power becomes larger on the positive side. If a group on the object side is a negative lens group having high refractive power, a height of a paraxial chief ray is changed due to variations in spacing at the time of replacing a lens, a spherical aberration occurs, and a field curvature also occurs simultaneously. At the time of replacing the lens, the spherical aberration and the field curvature cannot be simultaneously corrected only by fine adjustment of the spacing. In the disclosure, by reducing the refractive power of the first A lens group and that of the first B lens group to reduce an influence on the spherical aberration, it is possible to provide the imaging lens having a configuration of correcting the field curvature through a fine adjustment of the spacing.

In the manufacturing method, the first lens system (first lens apparatus) and the second lens system (second lens apparatus) are not shared. The manufacturing method includes a manufacturing start process in which manufacturing is started, a first manufacturing process in which the first lens apparatus is assembled by combining a first partial optical system, a first aperture stop, and a second partial optical system that are disposed in order from the object side to the image side, and a second manufacturing process in which the second lens apparatus is assembled by combining a third partial optical system, a second aperture stop, and a fourth partial optical system that are disposed in order from the object side to the image side. The second lens apparatus has a focal length longer than that of the first lens apparatus, and a total number of positive lenses disposed in the second partial optical system and a total number of positive lenses disposed in the fourth partial optical system are equal. A total number of negative lenses disposed in the second partial optical system and a total number of negative lenses disposed in the fourth partial optical system are equal. Furthermore, the following conditional expression is satisfied where a focal length of the second partial optical system is f2 and a focal length of the fourth partial optical system is f4.

$$0.9 < f 2 / f 4 < 1.1 \qquad ( 10 )$$

This makes it possible to use a lens in the fourth partial optical system also in the second partial optical system and manufacture lenses by sharing a mold or by adding a fine adjustment of a mold, and it is easy to manufacture a high-performance lens while reducing cost.

In one embodiment, a numeric value range in the conditional expression (10) is to be set as follows.

$$0.95 < f 2 / f 4 < 1.05 \qquad ( 10 a )$$

In yet another embodiment, the numeric value range in the conditional expression (10) is to be set as follows.

$$0.97 < f 2 / f 4 < 1.03 \qquad ( 10 b )$$

In the following manufacturing method, the first A lens group corresponds to the first partial optical system, the first B lens group corresponds to the third partial optical system, and the positive lens group corresponds to the second partial optical system or the fourth partial optical system.

In the first to third exemplary embodiments, the following conditional expressions are satisfied where a focal length of the positive lens group is fP, a focal length of the first A lens group is f1A, a focal length of the first B lens group is f1B, a focal length of each lens disposed in the positive lens group is fPi, and a refractive index of the lens is Ni, when focused at infinity.

$$0.01 < \vert fP / f 1 A \vert < 0.03 \qquad ( 1 )$$

$$0.01 < \vert fP / f 1 B \vert < 0.3 \qquad ( 2 )$$

$$0.02 < Σ1 / ( fPi \cdot Ni ) < 0.1 \qquad ( 3 )$$

The conditional expression (1) is a conditional expression that defines a ratio between the focal length of the first A lens group in the first lens system and the focal length of the second lens group. As described above, the first A lens group has low refractive power, and the second lens group has high refractive power on the positive side.

In a case where |fP/f1A| becomes small and falls below a lower limit value of the conditional expression (1), the refractive power of the second lens group becomes too high with respect to the refractive power of the first A lens group. When the refractive power of the second lens group becomes too high, the field curvature occurring in the second lens group becomes large. To compensate for this, the Petzval sum of the first A lens group is made large on the negative side. Hence, the sensitivity to spacing adjustments at the time of replacing a lens becomes excessively high, which is undesirable. Alternatively, the number of lenses may be increased to correct the field curvature of the second lens group, which leads to an increase in size of the optical system and is undesirable.

In a case where |fP/f1A| becomes large and exceeds an upper limit value of the conditional expression (1), the refractive power of the first A lens group becomes too high with respect to the refractive power of the second lens group. As a result, the spherical aberration and the field curvature are changed by the change in the spacing at the time of replacing the lens, which makes it difficult to simultaneously adjust two aberrations and thereby makes it difficult to achieve the high performance.

The conditional expression (2) is a conditional expression that defines a ratio between the focal length of the first B lens group in the second lens system and the focal length of the second lens group. As described above, the first B lens group has low refractive power, and the second lens group has high refractive power on the positive side.

In a case where |fP/f1B| becomes small and falls below a lower limit value of the conditional expression (2), the refractive power of the second lens group becomes too high with respect to the refractive power of the first B lens group. When the refractive power of the second lens group becomes too high, the field curvature occurring in the second lens group becomes large. To compensate for this, in one embodiment, the Petzval sum of the first B lens group is made large on the negative side. Hence, the sensitivity to spacing adjustments at the time of replacing the lens becomes excessively high, which is undesirable. Alternatively, the number of lenses may be increased to correct the field curvature of the second lens group, which leads to an increase in size of the optical system and is undesirable.

In a case where |fP/f1B| becomes large and exceeds an upper limit value of the conditional expression (2), the refractive power of the first B lens group becomes too high with respect to the refractive power of the second lens group. As a result, the spherical aberration and the field curvature are changed by the change in the spacing at the time of replacing the lens, which makes it difficult to simultaneously adjust two aberrations and thereby makes it difficult to achieve the high performance.

The conditional expression (3) is a conditional expression that defines the Petzval sum of the second lens group.

In a case where Σ1/(fPi·Ni) becomes small and falls below a lower limit value of the conditional expression (3), the Petzval sum is corrected for each of the first A lens group, the first B lens group, and the second lens group, so that the number of lenses increases, and the optical system becomes large. In particular, the number of lenses in the second lens group having high refractive power increases. This corresponds to a case where a converter lens is mounted on the object side of a normal imaging lens, and a large number of lenses are used to obtain a high-performance lens.

In a case where Σ1/(fPi·Ni) becomes large and exceeds an upper limit value of the conditional expression (3), an amount of field curvature that occurs in each group becomes too large. Hence, the sensitivity to spacing adjustments at the time of replacing the lens becomes excessively high, which is undesirable.

To implement a more compact, higher-performance front group interchangeable imaging lens, the respective numeric value ranges in the conditional expressions (1) to (3) are set as follows.

$$0.1 < \vert fP / f 1 A \vert < 0.3 \qquad ( 1 a )$$

$$0.05 < \vert fP / f 1 B \vert < 0.25 \qquad ( 2 a )$$

$$0.02 < Σ1 / ( fPi \cdot Ni ) < 0.08 \qquad ( 3 a )$$

In one embodiment, the respective numeric value ranges for the conditional expressions (1) to (3) are set as follows.

$$0.15 < \vert fP / f 1 A \vert < 0. 30 \qquad ( 1 b )$$

$$0.09 < \vert fP / f 1 B \vert < 0.23 \qquad ( 2 b )$$

$$0.02 < \sum 1 / ( fPi \cdot Ni ) < 0 \text{.07} \qquad ( 3 b )$$

In the disclosure, in yet another embodiment, one or more of the following conditions are satisfied.

$$0.01 < \vert ff 1 / f 1 A \vert < 0. 20 \qquad ( 4 )$$

$$0.01 < \vert ff 2 / f 1 B \vert < 0.2 \qquad ( 5 )$$

$$0.3 < LP / L 1 < 0.8 \qquad ( 6 )$$

$$0.8 < N 2 ave P / N 2 ave N < 1.5 \qquad ( 7 )$$

$$0.15 < D 1 A / DP < 1.5 \qquad ( 8 )$$

$$0.05 < BFinair / L 1 < 0.3 \qquad ( 9 )$$

In the above conditional expressions, ff1 indicates a focal length of the first lens system when focused at infinity, and ff2 indicates a focal length of the second lens system when focused at infinity. LP indicates a distance from a surface on the object side in the second lens group to the image plane, and L1 indicates a distance from a surface that is the closest to the object in the first lens system to the image plane. Further, N2aveP indicates an average refractive index of a positive lens included in the second lens group, and N2aveN indicates an average refractive index of a negative lens included in the second lens group.

The conditional expression (4) is a conditional expression that defines a ratio between the focal length of the first lens system and the focal length of the first A lens group in the first lens system.

In a case where |ff1/f1A| becomes small and falls below a lower limit value of the conditional expression (4), the refractive power of the first A lens group becomes too low relative to the refractive power of the entire first lens system. Thus, in one embodiment, the refractive power of the second lens group is increased. When the refractive power of the second lens group becomes high, the field curvature occurring in the second lens group becomes large. To compensate for this, the Petzval sum of the first A lens group is made large on the negative side. Hence, the sensitivity to spacing adjustments at the time of replacing the lens becomes excessively high, which is undesirable.

Alternatively, the number of lenses may be increased to correct the field curvature of the second lens group, which leads to an increase in size of the optical system and is undesirable.

In a case where |ff1/f1A| becomes large and exceeds an upper limit value of the conditional expression (4), the refractive power of the first A lens group becomes too high relative to the refractive power of the entire first lens system. As a result, the spherical aberration and the field curvature are changed by the change in the spacing at the time of replacing the lens in the first lens system, which makes it difficult to simultaneously adjust two aberrations and thereby makes it difficult to achieve the high performance.

The conditional expression (5) is a conditional expression that defines a ratio between the focal length of the first B lens group in the second lens system and the focal length of the second lens group.

In a case where |ff2/f1B| becomes small and falls below a lower limit value of the conditional expression (5), the refractive power of the first B lens group becomes too low relative to the refractive power of the entire second lens system. Thus, in one embodiment, the refractive power of the second lens group is increased. When the refractive power of the second lens group becomes high, the field curvature occurring in the second lens group becomes large. To compensate for this, the Petzval sum of the first B lens group is made large on the negative side. Hence, the sensitivity to spacing adjustments at the time of replacing the lens becomes excessively high, which is undesirable.

Alternatively, the number of lenses may be increased to correct the field curvature of the second lens group, which leads to an increase in size of the optical system and is undesirable.

In a case where |ff2/f1B| becomes large and exceeds an upper limit value of the conditional expression (5), the refractive power of the first B lens group becomes too high relative to the refractive power of the entire second lens group. As a result, the spherical aberration and the field curvature are changed by the change in the spacing at the time of replacing the lens in the second lens system, which makes it difficult to simultaneously adjust two aberrations and thereby makes it difficult to achieve the high performance.

The conditional expression (6) is a conditional expression that defines a ratio of a thickness of the second lens group to a total length of the first lens system.

In a case where LP/L1 becomes small and falls below a lower limit value of the conditional expression (6), the second lens group becomes too thin. Since the configuration includes the aperture stop on the image side of the first A lens group as described above, the aperture stop becomes too close to the image plane. As a result, an exit pupil becomes short, and an incident angle becomes steep. Thus, color shading or the like occurs, which is undesirable.

In a case where LP/L1 becomes large and exceeds an upper limit value of the conditional expression (6), the second lens group becomes too thick. If the second lens group is thick, the first A lens group becomes thin, which decreases a distance from the aperture stop to the most object-side surface of the first A lens group. As a result, the height of an object paraxial ray passing through the first A lens group becomes lower, which makes it difficult to correct the distortion aberration and the field curvature and poses an obstacle to performance. Alternatively, there arises the need for reducing the number of lenses that constitute the first A lens group, which makes it difficult to correct the chromatic aberration.

The conditional expression (7) is a conditional expression that defines a ratio between an average refractive index of a positive lens constituting the second lens group and an average refractive index of a negative lens constituting the second lens group.

In a case where N2aveP/N2aveN becomes small and falls below a lower limit value of the conditional expression (7), the average refractive index of the positive lens becomes too small, and the Petzval sum becomes large on the positive side. Hence, the sensitivity to spacing adjustments at the time of replacing the lens becomes excessively high, which is undesirable.

In a case where N2aveP/N2aveN becomes large and exceeds an upper limit value of the conditional expression (7), the average refractive index of the positive lens can be made large, which is advantageous in terms of the field curvature. However, because only a high-dispersion lens can be used as a result, correction of the chromatic aberration becomes insufficient, which is undesirable.

The conditional expression (8) is a conditional expression that defines a ratio between a thickness of the first A lens group and a thickness of the second lens group.

In a case where D1A/DP becomes small and falls below a lower limit value of the conditional expression (8), the positive lens becomes too thick, and the whole system increases in size.

In a case where D1A/DP becomes large and exceeds an upper limit value of the conditional expression (8), the positive lens having high refractive power becomes thin, which makes it difficult to dispose a lens for correcting the field curvature, and the performance is deteriorated.

The conditional expression (9) is a conditional expression that defines a ratio between a backfocus and the total length of the first lens system and defines miniaturization. Since the imaging lens of the disclosure is characterized by the configuration of replacing a lens group on the object side, it is suitable for lenses with a reduced backfocus, and by satisfying the ranges of the conditional expression, it is possible to miniaturize the entire imaging lens. In a case where the backfocus is too short, a scratch or dust on a lens surface may become visible on the image pickup device, which is undesirable.

In one embodiment, numeric value ranges in the conditional expressions (4) to (6) are set as follows.

$$0.05 < \vert ff 1 / f 1 A \vert < 0.20 \qquad ( 4 a )$$

$$0.05 < \vert ff 2 / f 1 B \vert < 0 \text{.20} \qquad ( 5 a )$$

$$0.4 < LP / L 1 < 0.75 \qquad ( 6 a )$$

$$0.9 < N 2 ave P / N 2 ave N < 1.2 \qquad ( 7 a )$$

$$0.3 < D 1 A / DP < 1. 3 \qquad ( 8 a )$$

$$0.08 < BFinair / L 1 < 0.2 \qquad ( 9 a )$$

In one embodiment, one or more of the following conditions are satisfied.

$$0.08 < \vert ff 1 / f 1 A \vert < 0.195 \qquad ( 4 b )$$

$$0.08 < \vert ff 2 / f 1 B \vert < 0.1 \; 95 \qquad ( 5 b )$$

$$0.5 < LP / L 1 < 0.72 \qquad ( 6 b )$$

$$0.92 < N 2 ave P / N 2 ave N < 1.15 \qquad ( 7 b )$$

$$0.5 < D 1 A / DP < 1. 1 \qquad ( 8 b )$$

$$0.1 < BFinair / L 1 < 0.15 \qquad ( 9 b )$$

Subsequently, first to third numerical examples respectively corresponding to the first to third exemplary embodiments are described. In each of the numerical examples, i indicates the order of optical surfaces from the object side, ri indicates a curvature radius of an i-th optical surface (i-th surface), di indicates a space between the i-th surface and an i+1-th surface, and ndi and vdi respectively indicate a refractive index and an Abbe number of a material of an i-th optical member with respect to the d-line.

Further, an aspherical shape is expressed by the following expression where k indicates eccentricity, A4, A6, A8, and A10 indicate aspherical coefficients, and displacement in the optical axis direction at a position of a height h from an optical axis with respect to a surface vertex is x.

$$x = ( {h}^{2} / R ) / [ 1 + {[ 1 - ( 1 + k ) {( h / R )}^{2} ]}^{1 / 2} ] + A 4 {h}^{4} + A 6 {h}^{6} + A 8 {h}^{8} + A 10 {h}^{10}$$

In this expression, R is a paraxial curvature radius. Further, for example, “E-Z” indicates “10^{-z}”. In the numerical examples, the last two surfaces are surfaces of optical blocks such as a filter or a face plate. In the numerical examples, a backfocus (BF) is a distance in air conversion from a surface closest to the image side in a lens group closest to the image side and having refractive power to a paraxial image plane. Table 1 indicates a correspondence relation between the numerical examples and the above-mentioned conditional expressions.

[First Numerical Example]
First lens system
Surface data

| Surface number | r | d | nd | νd | Effective diameter |
|---|---|---|---|---|---|
| 1 | 28.532 | 0.80 | 2.00100 | 29.1 | 18.00 |
| 2 | 9.738 | 2.38 | | | 13.50 |
| 3 | 35.887 | 0.60 | 1.72916 | 54.7 | 12.80 |
| 4 | 8.390 | 0.97 | | | 10.40 |
| 5 | 14.069 | 2.27 | 1.77830 | 23.9 | 10.20 |
| 6 | −48.500 | 0.87 | | | 9.20 |
| 7 | −13.342 | 0.50 | 1.69350 | 53.2 | 6.70 |
| 8* | 4.585 | 1.57 | | | 5.40 |
| 9 | 8.236 | 2.00 | 1.59270 | 35.3 | 5.00 |
| 10 | −7.313 | (variable) | | | 4.50 |
| 11(stop) | ∞ | 0.86 | | | 3.62 |
| 12* | 9.763 | 2.16 | 1.49710 | 81.6 | 4.00 |
| 13* | −15.297 | 0.10 | | | 5.00 |
| 14 | −10.490 | 0.35 | 1.77830 | 23.9 | 5.10 |
| 15 | 10.490 | 0.25 | | | 5.60 |
| 16* | 7.230 | 1.79 | 1.76802 | 49.2 | 5.80 |
| 17* | −7.324 | 1.97 | | | 6.30 |
| 18 | −23.609 | 0.40 | 1.76182 | 26.5 | 7.90 |
| 19 | 15.979 | 2.12 | | | 8.50 |
| 20* | 36.613 | 2.41 | 1.63560 | 23.9 | 12.10 |
| 21* | −27.501 | (variable) | | | 12.30 |
| 22 | ∞ | 1.00 | 1.51633 | 64.1 | 14.00 |
| 23 | ∞ | (variable) | | | 14.00 |
| Image plane | ∞ | | | | |

Aspherical surface data
Eighth surface

| | | | | |
|---|---|---|---|---|
| K = | A4 = | A6 = | A8 = | A10 = |
| 0.00000e+000 | 4.27645e−004 | 1.01149e−004 | −1.26872e−005 | 2.04569e−007 |

Twelfth surface

| | | | | | |
|---|---|---|---|---|---|
| K = | A4 = | A6 = | A8 = | A10 = | A12 = |
| 0.00000e+000 | −2.93772e−003 | 2.15270e−004 | −1.06245e−004 | 1.17246e−005 | −1.47530e−006 |

Thirteenth surface

| | | | | | |
|---|---|---|---|---|---|
| K = | A4 = | A6 = | A8 = | A10 = | A12 = |
| 0.00000e+000 | −1.72367e−002 | 2.14408e−003 | −2.10511e−004 | 9.85190e−006 | −5.30549e−007 |

Sixteenth surface

| | | | | |
|---|---|---|---|---|
| K = | A4 = | A6 = | A8 = | A10 = |
| 0.00000e+000 | −8.72413e−003 | 7.34397e−004 | −2.99277e−005 | 1.75556e−007 |

Seventeenth surface

| | | | | |
|---|---|---|---|---|
| K = | A4 = | A6 = | A8 = | A10 = |
| 0.00000e+000 | 1.30281e−003 | −3.06018e−004 | 3.66480e−005 | −1.32288e−006 |

Twentieth surface

| | | | | | | |
|---|---|---|---|---|---|---|
| K = | A4 = | A6 = | A8 = | A10 = | A12 = | A14 = |
| 0.00000e+000 | 2.40907e−003 | −2.28373e−004 | 1.21252e−005 | −3.42829e−007 | 5.04162e−009 | −3.08266e−011 |

Twenty-first surface

| | | | | | |
|---|---|---|---|---|---|
| K = | A4 = | A6 = | A8 = | A10 = | A12 = |
| 0.00000e+000 | 3.02717e−003 | −2.34941e−004 | 8.48720e−006 | −1.41285e−007 | 8.67693e−010 |

Various data

| | |
|---|---|
| Zoom ratio | 1.00 |
| Focal length | 4.52 |
| F-number | 2.94 |
| Angle of view | 55.08 |
| Image height | 6.47 |
| Total lens length | 29.56 |
| BF (in air) | 3.37 |
| d10 | 1.47 |
| d21 | 1.71 |
| d23 | 1.00 |

Second lens system
Surface data

| Surface number | r | d | nd | νd | Effective diameter |
|---|---|---|---|---|---|
| 1 | 10.588 | 5.70 | 1.53775 | 74.7 | 17.80 |
| 2 | 26.320 | 1.09 | | | 14.10 |
| 3 | 12.615 | 0.50 | 1.91082 | 35.3 | 9.40 |
| 4 | 4.185 | 3.20 | | | 6.90 |
| 5* | −12.183 | 0.50 | 1.68948 | 31.0 | 5.40 |
| 6 | 5.000 | 0.34 | | | 4.80 |
| 7 | 6.327 | 1.87 | 2.00069 | 25.5 | 4.80 |
| 8 | −14.235 | (variable) | | | 4.20 |
| 9(stop) | ∞ | 0.86 | | | 3.62 |
| 10* | 9.763 | 2.16 | 1.49710 | 81.6 | 4.00 |
| 11* | −15.297 | 0.10 | | | 5.00 |
| 12 | −10.490 | 0.35 | 1.77830 | 23.9 | 5.10 |
| 13 | 10.490 | 0.25 | | | 5.60 |
| 14* | 7.230 | 1.79 | 1.76802 | 49.2 | 5.80 |
| 15* | −7.324 | 1.97 | | | 6.30 |
| 16 | −23.609 | 0.40 | 1.76182 | 26.5 | 7.90 |
| 17 | 15.979 | 2.12 | | | 8.50 |
| 18* | 36.613 | 2.41 | 1.63560 | 23.9 | 12.10 |
| 19* | −27.501 | (variable) | | | 12.30 |
| 20 | ∞ | 1.00 | 1.51633 | 64.1 | 14.00 |
| 21 | ∞ | (variable) | | | 14.00 |
| Image plane | ∞ | | | | |

Aspherical surface data
Fifth surface

| | | | |
|---|---|---|---|
| K = | A4 = | A6 = | A8 = |
| −9.49305e+000 | −6.01723e−004 | −2.45714e−005 | 4.60567e−006 |

Tenth surface

| | | | | | |
|---|---|---|---|---|---|
| K = | A4 = | A6 = | A8 = | A10 = | A12 = |
| 0.00000e+000 | −2.93772e−003 | 2.15270e−004 | −1.06245e−004 | 1.17246e−005 | −1.47530e−006 |

Eleventh surface

| | | | | | |
|---|---|---|---|---|---|
| K = | A4 = | A6 = | A8 = | A10 = | A12 = |
| 0.00000e+000 | −1.72367e−002 | 2.14408e−003 | −2.10511e−004 | 9.85190e−006 | −5.30549e−007 |

Fourteenth surface

| | | | | |
|---|---|---|---|---|
| K = | A4 = | A6 = | A8 = | A10 = |
| 0.00000e+000 | −8.72413e−003 | 7.34397e−004 | −2.99277e−005 | 1.75556e−007 |

Fifteenth surface

| | | | | |
|---|---|---|---|---|
| K = | A4 = | A6 = | A8 = | A10 = |
| 0.00000e+000 | 1.30281e−003 | −3.06018e−004 | 3.66480e−005 | −1.32288e−006 |

Eighteenth surface

| | | | | | | |
|---|---|---|---|---|---|---|
| K = | A4 = | A6 = | A8 = | A10 = | A12 = | A14 = |
| 0.00000e+000 | 2.40907e−003 | −2.28373e−004 | 1.21252e−005 | −3.42829e−007 | 5.04162e−009 | −3.08266e−011 |

Nineteenth surface

| | | | | | |
|---|---|---|---|---|---|
| K = | A4 = | A6 = | A8 = | A10 = | A12 = |
| 0.00000e+000 | 3.02717e−003 | −2.34941e−004 | 8.48720e−006 | −1.41285e−007 | 8.67693e−010 |

Various data

| | |
|---|---|
| Zoom ratio | 1.00 |
| Focal length | 8.53 |
| F-number | 2.88 |
| Angle of view | 37.18 |
| Image height | 6.47 |
| Total lens length | 30.63 |
| BF (in air) | 3.37 |
| d8 | 1.31 |
| d19 | 1.71 |
| d21 | 1.00 |

(Second Numerical Example)
First lens system
Surface data

| Surface | | | | | Effective |
|---|---|---|---|---|---|
| number | r | d | nd | νd | diameter |
| 1 | −39.417 | 0.50 | 1.49700 | 81.5 | 7.70 |
| 2 | 4.131 | 1.66 | | | 6.00 |
| 3 | 8.146 | 2.00 | 1.88300 | 40.8 | 5.50 |
| 4 | −18.336 | 0.68 | | | 4.70 |
| 5* | −8.135 | 0.40 | 2.00100 | 29.1 | 3.60 |
| 6 | 15.682 | 1.57 | 1.59270 | 35.3 | 3.70 |
| 7 | −5.528 | (variable) | | | 4.00 |
| 8(stop) | ∞ | 0.72 | | | 3.88 |
| 9 | 15.876 | 1.74 | 2.00100 | 29.1 | 4.50 |
| 10 | −6.459 | 0.16 | | | 4.90 |
| 11 | −5.870 | 0.50 | 1.92286 | 18.9 | 4.80 |
| 12 | 38.746 | 3.57 | | | 5.30 |
| 13 | −49.996 | 1.61 | 1.85135 | 40.1 | 8.30 |
| 14* | −8.656 | 1.61 | | | 8.70 |
| 15 | −8.203 | 0.50 | 1.59270 | 35.3 | 9.10 |
| 16 | 28.695 | 0.10 | | | 10.50 |
| 17 | 20.020 | 1.95 | 2.00100 | 29.1 | 11.20 |
| 18 | 991.458 | (variable) | | | 11.50 |
| 19 | ∞ | 1.00 | 1.51633 | 64.1 | 16.00 |
| 20 | ∞ | (variable) | | | 16.00 |
| Image plane | ∞ | | | | |

Aspherical surface data
Fourteenth surface

| | | | |
|---|---|---|---|
| K = | A4 = | A6 = | A8 = |
| −4.96723e+000 | −6.36810e−004 | 1.72414e−005 | −1.66807e−007 |

Various data

| | |
|---|---|
| Zoom ratio | 1.00 |
| Focal length | 8.41 |
| F-number | 2.88 |
| Angle of view | 37.57 |
| Image height | 6.47 |
| Total lens length | 23.34 |
| BF (in air) | 3.24 |
| d7 | 0.50 |
| d18 | 1.58 |
| d20 | 1.00 |

Second lens system
Surface data

| Surface | | | | | Effective |
|---|---|---|---|---|---|
| number | r | d | nd | νd | diameter |
| 1 | −21.959 | 0.50 | 1.59270 | 35.3 | 5.30 |
| 2 | 5.138 | 0.28 | | | 4.60 |
| 3 | 6.342 | 1.33 | 1.95375 | 32.3 | 4.60 |
| 4 | −319.485 | (variable) | | | 4.00 |
| 5(stop) | ∞ | 0.72 | | | 3.88 |
| 6 | 15.876 | 1.74 | 2.00100 | 29.1 | 4.50 |
| 7 | −6.459 | 0.16 | | | 4.90 |
| 8 | −5.870 | 0.50 | 1.92286 | 18.9 | 4.80 |
| 9 | 38.746 | 3.57 | | | 5.30 |
| 10 | 49.996 | 1.61 | 1.85135 | 40.1 | 8.30 |
| 11* | −8.656 | 1.61 | | | 8.70 |
| 12 | −8.203 | 0.50 | 1.59270 | 35.3 | 9.10 |
| 13 | 28.695 | 0.10 | | | 10.50 |
| 14 | 20.020 | 1.95 | 2.00100 | 29.1 | 11.20 |
| 15 | 991.458 | (variable) | | | 11.50 |
| 16 | ∞ | 1.00 | 1.51633 | 64.1 | 16.00 |
| 17 | ∞ | (variable) | | | 16.00 |
| Image plane | ∞ | | | | |

Aspherical surface data
Eleventh surface

| | | | |
|---|---|---|---|
| K = | A4 = | A6 = | A8 = |
| −4.96723e+000 | −6.36810e−004 | 1.72414e−005 | −1.66807e−007 |

Various data

| | |
|---|---|
| Zoom ratio | 1.00 |
| Focal length | 10.98 |
| F-number | 2.88 |
| Angle of view | 30.51 |
| Image height | 6.47 |
| Total lens length | 20.19 |
| BF (in air) | 3.24 |
| d4 | 2.05 |
| d15 | 1.58 |
| d17 | 1.00 |

(Third Numerical Example)
First lens system
Surface data

| Surface number | r | d | nd | νd | Effective diameter |
|---|---|---|---|---|---|
| 1* | −4.513 | 0.30 | 1.53110 | 55.9 | 3.50 |
| 2* | 2.519 | 0.45 | | | 2.20 |
| 3* | 2.449 | 0.45 | 1.63560 | 23.9 | 2.00 |
| 4* | 3.264 | 0.24 | | | 2.20 |
| 5* | 9.626 | 0.71 | 1.53110 | 55.9 | 2.40 |
| 6* | −3.077 | (variable) | | | 2.50 |
| 7(stop) | ∞ | 0.00 | | | 2.42 |
| 8* | 2.830 | 0.81 | 1.53110 | 55.9 | 2.50 |
| 9* | −3.182 | 0.31 | | | 2.30 |
| 10* | −1.823 | 0.25 | 1.67070 | 19.3 | 2.40 |
| 11* | −3.148 | 0.30 | | | 2.60 |
| 12* | 7.979 | 0.40 | 1.67070 | 19.3 | 3.10 |
| 13* | 5.151 | 0.37 | | | 3.70 |
| 14* | −13.080 | 0.57 | 1.53110 | 55.9 | 3.80 |
| 15* | −2.535 | 0.36 | | | 4.30 |
| 16* | −5.613 | 0.61 | 1.53110 | 55.9 | 4.90 |
| 17* | 3.432 | (variable) | | | 6.50 |
| 18 | ∞ | 0.50 | 1.51633 | 64.1 | 8.00 |
| 19 | ∞ | (variable) | | | 8.00 |
| Image plane | ∞ | | | | |

Aspherical surface data
First surface

| | | | | | |
|---|---|---|---|---|---|
| K = | A4 = | A6 = | A8 = | A10 = | A12 = |
| 0.00000e+000 | 7.89744e−002 | −2.94228e−002 | 8.24147e−003 | −1.60682e−003 | 1.45539e−004 |

Second surface

| | | | | | |
|---|---|---|---|---|---|
| K = | A4 = | A6 = | A8 = | A10 = | A12 = |
| 0.00000e+000 | 4.71755e−002 | 4.56983e−002 | −3.98462e−002 | 3.55135e−002 | −9.43780e−003 |

Third surface

| | | | | | |
|---|---|---|---|---|---|
| K = | A4 = | A6 = | A8 = | A10 = | A12 = |
| 0.00000e+000 | −9.21224e−002 | 8.31161e−003 | −2.20693e−002 | 1.43813e−002 | −6.41808e−003 |

Fourth surface

| | | | | | |
|---|---|---|---|---|---|
| K = | A4 = | A6 = | A8 = | A10 = | A12 = |
| 0.00000e+000 | −6.13004e−003 | −2.62918e−002 | 1.98964e−002 | −2.68404e−002 | 9.28136e−003 |

Fifth surface

| | | | | | |
|---|---|---|---|---|---|
| K = | A4 = | A6 = | A8 = | A10 = | A12 = |
| 0.00000e+000 | 4.41146e−002 | −1.31930e−003 | −3.65416e−003 | −1.75153e−003 | −1.97985e−003 |

Sixth surface

| | | | | | |
|---|---|---|---|---|---|
| K = | A4 = | A6 = | A8 = | A10 = | A12 = |
| 0.00000e+000 | −1.46227e−002 | 3.46387e−003 | −1.58619e−003 | 5.77662e−003 | −4.53954e−003 |

Eighth surface

| | | | | | |
|---|---|---|---|---|---|
| K = | A4 = | A6 = | A8 = | A10 = | A12 = |
| 0.00000e+000 | −2.53143e−003 | 2.42501e−003 | −7.05389e−004 | 1.40080e−003 | −3.28669e−004 |

Ninth surface

| | | | | | |
|---|---|---|---|---|---|
| K = | A4 = | A6 = | A8 = | A10 = | A12 = |
| 0.00000e+000 | −2.65470e−002 | 7.21846e−003 | 1.13827e−002 | −3.88763e−003 | 1.50814e−004 |

Tenth surface

| | | | | | |
|---|---|---|---|---|---|
| K = | A4 = | A6 = | A8 = | A10 = | A12 = |
| 0.00000e+000 | 8.86329e−002 | 3.77122e−002 | −3.35627e−002 | 1.24171e−002 | −2.53504e−003 |

Eleventh surface

| | | | | | |
|---|---|---|---|---|---|
| K = | A4 = | A6 = | A8 = | A10 = | A12 = |
| 0.00000e+000 | 9.93444e−002 | 3.59588e−002 | −2.90860e−002 | 9.17142e−003 | −1.27442e−003 |

Twelfth surface

| | | | | | |
|---|---|---|---|---|---|
| K = | A4 = | A6 = | A8 = | A10 = | A12 = |
| 0.00000e+000 | −6.73654e−002 | 1.71258e−002 | −5.17064e−003 | 2.52327e−003 | −6.17873e−004 |

Thirteenth surface

| | | | | | |
|---|---|---|---|---|---|
| K = | A4 = | A6 = | A8 = | A10 = | A12 = |
| 0.00000e+000 | −7.29890e−002 | 2.02941e−002 | −6.15148e−003 | 1.95317e−003 | −2.96023e−004 |

Fourteenth surface

| | | | | | |
|---|---|---|---|---|---|
| K = | A4 = | A6 = | A8 = | A10 = | A12 = |
| 0.00000e+000 | −5.35027e−002 | 2.03321e−002 | −5.00558e−003 | 6.55710e−004 | −3.47856e−005 |

Fifteenth surface

| | | | | | |
|---|---|---|---|---|---|
| K = | A4= | A6 = | A8 = | A10 = | A12 = |
| 0.00000e+000 | 1.40884e−002 | 1.50063e−003 | 1.47795e−003 | −5.17366e−004 | 4.99945e−005 |

Sixteenth surface

| | | | | | |
|---|---|---|---|---|---|
| K = | A4 = | A6 = | A8 = | A10 = | A12 = |
| 0.00000e+000 | −1.79942e−003 | −8.21842e−003 | 2.00600e−003 | −9.82724e−005 | −3.69235e−006 |

Seventeenth surface

| | | | | | |
|---|---|---|---|---|---|
| K = | A4 = | A6 = | A8 = | A10 = | A12 = |
| 0.00000e+000 | −4.05291e−002 | 4.61670e−003 | −4.32837e−004 | 2.30741e−005 | −9.39199e−007 |

Various data

| | |
|---|---|
| Zoom ratio | 1.00 |
| Focal length | 3.37 |
| F-number | 2.06 |
| Angle of view | 49.03 |
| Image height | 3.88 |
| Total lens length | 7.51 |
| BF (in air) | 1.09 |
| d6 | 0.10 |
| d17 | 0.36 |
| d19 | 0.40 |

Second lens system
Surface data

| Surface number | r | d | nd | νd | Effective diameter |
|---|---|---|---|---|---|
| 1* | −5.680 | 0.50 | 1.63560 | 23.9 | 3.40 |
| 2* | 15.064 | 0.66 | | | 2.50 |
| 3* | 2.197 | 0.86 | 1.61550 | 25.8 | 1.80 |
| 4* | 4.874 | (variable) | | | 1.70 |
| 5(stop) | ∞ | 0.00 | | | 1.62 |
| 6* | 2.830 | 0.81 | 1.53110 | 55.9 | 2.50 |
| 7* | −3.182 | 0.31 | | | 2.30 |
| 8* | −1.823 | 0.25 | 1.67070 | 19.3 | 2.40 |
| 9* | −3.148 | 0.30 | | | 2.60 |
| 10* | 7.979 | 0.40 | 1.67070 | 19.3 | 3.10 |
| 11* | 5.151 | 0.37 | | | 3.70 |
| 12* | −13.080 | 0.57 | 1.53110 | 55.9 | 3.80 |
| 13* | −2.535 | 0.36 | | | 4.30 |
| 14* | −5.613 | 0.61 | 1.53110 | 55.9 | 4.90 |
| 15* | 3.432 | (variable) | | | 6.50 |
| 16 | ∞ | 0.50 | 1.51633 | 64.1 | 8.00 |
| 17 | ∞ | (variable) | | | 8.00 |
| Image plane | ∞ | | | | |

Aspherical surface data
First surface

| | | | | | |
|---|---|---|---|---|---|
| K = | A4 = | A6 = | A8 = | A10 = | A12 = |
| 0.00000e+000 | 1.24548e−001 | −4.90804e−002 | 1.71391e−002 | −3.50156e−003 | 2.85105e−004 |

Second surface

| | | | | | |
|---|---|---|---|---|---|
| K = | A4 = | A6 = | A8 = | A10 = | A12 = |
| 0.00000e+000 | 1.64816e−001 | −2.23879e−002 | −3.21306e−003 | 1.81730e−002 | −5.57023e−003 |

Third surface

| | | | | | |
|---|---|---|---|---|---|
| K = | A4 = | A6 = | A8 = | A10 = | A12 = |
| 0.00000e+000 | 3.09562e−002 | 2.58767e−003 | −2.82627e−003 | 6.77709e−003 | −9.17677e−004 |

Fourth surface

| | | | | | |
|---|---|---|---|---|---|
| K = | A4 = | A6 = | A8 = | A10 = | A12 = |
| 0.00000e+000 | 1.63288e−002 | −2.64447e−002 | 9.64590e−002 | −9.67115e−002 | 4.76898e−002 |

Sixth surface

| | | | | | |
|---|---|---|---|---|---|
| K = | A4 = | A6 = | A8 = | A10 = | A12 = |
| 0.00000e+000 | −2.53143e−003 | 2.42501e−003 | −7.05389e−004 | 1.40080e−003 | −3.28669e−004 |

Seventh surface

| | | | | | |
|---|---|---|---|---|---|
| K = | A4 = | A6 = | A8 = | A10 = | A12 = |
| 0.00000e+000 | −2.65470e−002 | 7.21846e−003 | 1.13827e−002 | −3.88763e−003 | 1.50814e−004 |

Eighth surface

| | | | | | |
|---|---|---|---|---|---|
| K = | A4 = | A6 = | A8 = | A10 = | A12 = |
| 0.00000e+000 | 8.86329e−002 | 3.77122e−002 | −3.35627e−002 | 1.24171e−002 | −2.53504e−003 |

Ninth surface

| | | | | | |
|---|---|---|---|---|---|
| K = | A4 = | A6 = | A8 = | A10 = | A12 = |
| 0.00000e+000 | 9.93444e−002 | 3.59588e−002 | −2.90860e−002 | 9.17142e−003 | −1.27442e−003 |

Tenth surface

| | | | | | |
|---|---|---|---|---|---|
| K = | A4 = | A6 = | A8 = | A10 = | A12 = |
| 0.00000e+000 | −6.73654e−002 | 1.71258e−002 | −5.17064e−003 | 2.52327e−003 | −6.17873e−004 |

Eleventh surface

| | | | | | |
|---|---|---|---|---|---|
| K = | A4 = | A6 = | A8 = | A10 = | A12 = |
| 0.00000e+000 | −7.29890e−002 | 2.02941e−002 | −6.15148e−003 | 1.95317e−003 | −2.96023e−004 |

Twelfth surface

| | | | | | |
|---|---|---|---|---|---|
| K = | A4 = | A6 = | A8 = | A10 = | A12 = |
| 0.00000e+000 | −5.35027e−002 | 2.03321e−002 | −5.00558e−003 | 6.55710e−004 | −3.47856e−005 |

Thirteenth surface

| | | | | | |
|---|---|---|---|---|---|
| K = | A4 = | A6 = | A8 = | A10 = | A12 = |
| 0.00000e+000 | 1.40884e−002 | 1.50063e−003 | 1.47795e−003 | −5.17366e−004 | 4.99945e−005 |

Fourteenth surface

| | | | | | |
|---|---|---|---|---|---|
| K = | A4 = | A6 = | A8 = | A10 = | A12 = |
| 0.00000e+000 | −1.79942e−003 | −8.21842e−003 | 2.00600e−003 | −9.82724e−005 | −3.69235e−006 |

Fifteenth surface

| | | | | | |
|---|---|---|---|---|---|
| K = | A4 = | A6 = | A8 = | A10 = | A12 = |
| 0.00000e+000 | −4.05291e−002 | 4.61670e−003 | −4.32837e−004 | 2.30741e−005 | −9.39199e−007 |

Various data

| | |
|---|---|
| Zoom ratio | 1.00 |
| Focal length | 4.32 |
| F-number | 2.89 |
| Angle of view | 41.87 |
| Image height | 3.88 |
| Total lens length | 7.84 |
| BF (in air) | 1.09 |
| d4 | 0.56 |
| d15 | 0.36 |
| d17 | 0.40 |

TABLE 1

| | | 1st | 1st | 2nd | 2nd | 3rd | 3rd |
|---|---|---|---|---|---|---|---|
| | | Numerical | Numerical | Numerical | Numerical | Numerical | Numerical |
| | | Example | Example | Example | Example | Example | Example |
| | | (A) | (B) | (A) | (B) | (A) | (B) |
| | fP | 9.853 | 9.853 | 12.937 | 12.937 | 5.458 | 5.458 |
| | f1A | −55.703 | — | 44.018 | — | 25.465 | — |
| | f1B | — | −105.113 | — | 57.451 | — | 32.732 |
| | ff1 | 4.517 | — | 8.409 | — | 3.365 | — |
| | ff2 | — | 8.530 | — | 10.977 | — | 4.323 |
| | LP | 15.273 | — | 15.313 | — | 5.258 | — |
| | L1 | 29.565 | — | 23.336 | — | 7.507 | — |
| | N2aveP | 1.634 | 1.634 | 1.951 | 1.951 | 1.531 | 1.531 |
| | N2aveN | 1.770 | 1.770 | 1.758 | 1.758 | 1.624 | 1.624 |
| | D1A | 11.967 | — | 6.803 | — | 2.149 | — |
| | DP | 11.563 | 11.563 | 11.730 | 11.729 | 3.995 | 3.995 |
| | BFinair | 3.37 | 3.37 | 3.24 | 3.24 | 1.09 | 1.09 |
| (1) | \|fP/f1A\| | 0.177 | — | 0.294 | — | 0.214 | — |
| (2) | \|fP/f1B\| | — | 0.094 | — | 0.225 | — | 0.167 |
| (3) | Σ1/(fPi · Ni) | 0.062 | 0.062 | 0.021 | 0.021 | 0.055 | 0.055 |
| (4) | \|ff1/f1A\| | 0.081 | — | 0.191 | — | 0.132 | — |
| (5) | \|ff2/f1B\| | — | 0.081 | — | 0.191 | — | 0.132 |
| (6) | LP/L1 | 0.517 | — | 0.656 | — | 0.700 | — |
| (7) | N2aveP/ | 0.923 | 0.923 | 1.110 | 1.110 | 0.943 | 0.943 |
| | N2aveN | | | | | | |
| (8) | D1A/DP | 1.035 | — | 0.580 | — | 0.538 | — |
| (9) | BFinair/L1 | 0.114 | — | 0.139 | — | 0.146 | — |

Subsequently, an exemplary embodiment of a digital still camera using the imaging lens described in each exemplary embodiment as an imaging optical system is described with reference to FIG. 7.

FIG. 7 illustrates a camera main body 20 and an imaging optical system 21 including the imaging lens described in any of the first to third exemplary embodiments. A solid-state image pickup device 22 is a solid-state image pickup device (photoelectric conversion device) such as a CCD sensor or a CMOS sensor that is built into the camera main body 20 and receives light of a subject image formed by the imaging optical system 21. A memory 23 is a memory that records information corresponding to the subject image photoelectrically converted by the solid-state image pickup device 22. A finder 24 is a finder including a liquid crystal display panel or the like and used to observe the subject image formed on the solid-state image pickup device 22.

In this manner, by applying the imaging lens of the disclosure to the imaging apparatus such as the digital still camera, it is possible to realize the imaging apparatus including the imaging lens that is compact and high-performance and capable of switching between two specifications.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Applications No. 2024-110109, filed Jul. 9, 2024, and No. 2025-072234, filed Apr. 24, 2025, which are hereby incorporated by reference herein in their entirety.

What is claimed is:

1. An imaging lens comprising:
a first lens system including a first A lens group closest to an object and a positive lens group disposed on an image side of the first A lens group; and
a second lens system in which a first B lens group is disposed in place of the first A lens group to set a focal length of an entire system to a telephoto side,
wherein following conditional expressions are satisfied:
$$0.01 < \vert fP / f 1 A \vert < 0. 30 ,$$
$$0.01 \text{<\textbar} fP / f 1 B \vert < 0.3 ,$$
$$and$$
$$0.02 < \sum 1 / ( fPi \cdot Ni ) < 0.10 ,$$
where, when focused at infinity, fp indicates a focal length of the positive lens group, f1A indicates a focal length of the first A lens group, f1B indicates a focal length of the first B lens group, fPi indicates a focal length of each lens disposed in the positive lens group, and Ni indicates a refractive index of the lens.

2. The imaging lens according to claim 1, wherein the imaging lens satisfies following conditional expressions:
$$0.01 < \vert ff 1 / f 1 A \vert < 0.2 ,$$
$$and$$
$$0.01 < \vert ff 2 / f 1 B \vert < 0. 20 ,$$
where ff1 indicates a focal length of the first lens system, and ff2 indicates a focal length of the second lens system, when focused at infinity.

3. The imaging lens according to claim 1, wherein the imaging lens satisfies a following conditional expression:
$$0.3 < LP / L 1 < 0.8 ,$$
where LP indicates a distance from a surface on an object side of the positive lens group to an image plane, and L1 indicates a distance from a surface closest to the object of the first lens system to the image plane.

4. The imaging lens according to claim 1, wherein the imaging lens satisfies a following conditional expression:
$$0.8 < N 2 ave P / N 2 ave N < 1.5 ,$$
where N2aveP indicates an average refractive index of a positive lens included in a second lens group, and N2aveN indicates an average refractive index of a negative lens included in the second lens group.

5. The imaging lens according to claim 1, further comprising an aperture stop on the image side of the first A lens group in the first lens system or the first B lens group in the second lens system.

6. The imaging lens according to claim 1, wherein the imaging lens is configured to move at least part of the positive lens group during focusing.

7. The imaging lens according to claim 1, wherein the number of lenses in the first A lens group is larger than the number of lenses in the first B lens group.

8. The imaging lens according to claim 1, wherein the number of aspherical lenses in the positive lens group is larger than the number of aspherical lenses in the first A lens group.

9. The imaging lens according to claim 1, wherein the number of aspherical lenses in the positive lens group is larger than the number of aspherical lenses in the first B lens group.

10. The imaging lens according to claim 1, wherein the first A lens group in the imaging lens includes at least one positive lens and at least one negative lens.

11. The imaging lens according to claim 1, wherein the first B lens group in the imaging lens includes at least one positive lens and at least one negative lens.

12. The imaging lens according to claim 1, wherein the positive lens group in the imaging lens includes at least one positive lens, at least one negative lens, and an aspherical lens.

13. The imaging lens according to claim 1, wherein the imaging lens satisfies a following conditional expression:
$$0.15 < D 1 A / DP < 1.5 ,$$
where D1A indicates a distance on an optical axis from a surface closest to the object to a surface closest to the image in the first A lens group, and DP is a distance on the optical axis from a surface closest to the object to a surface closest to the image in the positive lens group.

14. The imaging lens according to claim 1, wherein the imaging lens satisfies a following conditional expression:
$$0.05 < BFinair / L 1 < 0.3 ,$$
where BFinair indicates a length in air conversion of a backfocus in the first lens system and L1 indicates a distance from a surface closest to the object in the first lens system to an image plane.

15. A method for manufacturing a first lens apparatus and a second lens apparatus, the method comprising:
assembling the first lens apparatus by combining a first partial optical system, a first aperture stop, and a second partial optical system disposed in order from an object side to an image side; and
assembling the second lens apparatus by combining a third partial optical system, a second aperture stop, and a fourth partial optical system disposed in order from the object side to the image side,
wherein a focal length of the second lens apparatus is longer than a focal length of the first lens apparatus,
wherein a total number of positive lenses disposed in the second partial optical system and a total number of positive lenses disposed in the fourth partial optical system are equal,
wherein a total number of negative lenses disposed in the second partial optical system and a total number of negative lenses disposed in the fourth partial optical system are equal, and
wherein following conditional expressions are satisfied:
$$0.01 < \vert fP / flA \vert < 0. 30 ,$$
$$0.01 < \vert fP / flB \vert < 0. 30 ,$$
$$0.02 < \sum 1 / ( fPi \cdot Ni ) < 0 \text{.10} ,$$
$$and$$
$$0.9 < f 2 / f 4 < 1.10 ,$$
where a focal length of the first partial optical system is f1A, a focal length of the third partial optical system is f1B, a focal length of each lens disposed in the second partial optical system is fPi, a refractive index is Ni, a focal length of the second partial optical system is f2, and a focal length of the fourth partial optical system is f4.

16. The method according to claim 15, wherein the imaging lens satisfies following conditional expressions:
$$0.01 < \vert ff 1 / f 1 A \vert < 0.2 ,$$
$$and$$
$$0.01 < \vert ff 2 / f 1 B \vert < 0. 20 ,$$
where ff1 indicates a focal length of the first lens system, and ff2 indicates a focal length of the second lens system, when focused at infinity.

17. The method according to claim 15, wherein the imaging lens satisfies a following conditional expression:
$$0.3 < LP / L 1 < 0.8 ,$$
where LP indicates a distance from a surface on an object side of the positive lens group to an image plane, and L1 indicates a distance from a surface closest to the object of the first lens system to the image plane.

18. The method according to claim 15, wherein the imaging lens satisfies a following conditional expression:
$$0.8 < N 2 ave P / N 2 ave N < 1.5 ,$$
where N2aveP indicates an average refractive index of a positive lens included in a second lens group, and N2aveN indicates an average refractive index of a negative lens included in the second lens group.

19. The method according to claim 15, further comprising an aperture stop on the image side of the first A lens group in the first lens system or the first B lens group in the second lens system.

20. The method according to claim 15, wherein the imaging lens is configured to move at least part of the positive lens group during focusing.
